(19) United States
(12) Patent Application Publication
(10) Pub. No.: US 2026/0357091 A1
(43) Pub. Date: Nov. 12, 2026

(54) INSULATING MATERIAL, LITZ WIRE WITH SUCH A MATERIAL, CABLE WITH SUCH A MATERIAL, HEATABLE MEDIA LINE WITH AT LEAST ONE SUCH LITZ WIRE OR ONE SUCH CABLE, AND METHOD FOR PRODUCING SUCH AN INSULATING MATERIAL

(71) Applicant: VOSS AUTOMOTIVE GMBH, Wipperfürth (DE)

(72) Inventors: Heinz SPELTHANN, Issum (DE); Tobias ETSCHEID, Lindlar (DE)

(21) Appl. No.: 19/133,011

(22) PCT Filed: Nov. 25, 2023
(86) PCT No.: PCT/EP2023/025499

§ 371 Date: May 27, 2025

(30) Foreign Application Priority Data
Nov. 30, 2022 (DE) 10 2022 004 484.6

(51) Int. Cl. C09D 7/63; C08K 5/09; C09D 7/80; C09D 167/00; H01B 3/42; H01B 7/00; H01B 7/28

(52) U.S. Cl. CPC C09D 7/63; C09D 7/80; C09D 167/00; H01B 3/421; H01B 7/0009; H01B 7/2813; C08K 5/09

(57) ABSTRACT

In an insulating material, wherein the insulating material contains thermoplastic copolyester elastomer (TPC), at least one organic fatty acid is incorporated in the insulating material containing thermoplastic copolyester elastomer (TPC) in order to provide resistance to concentrated sodium hydroxide (NaOH).

### FIELD OF THE INVENTION

The invention relates to an insulating material for strands and/or cables, wherein the insulating material contains thermoplastic copolyester elastomer (TPC), a strand comprising at least one strand core and at least one strand sheath, a cable comprising at least two strands and at least one insulating sheath encasing the at least two strands, a heatable media line comprising at least one tubular or hose-shaped media line with at least one line wall and at least one heating element, wherein the at least one heating element for heating the at least one tubular or hose-shaped media line is arranged on its outside and/or inside and/or in its line wall, and a method for producing such an insulating material.

### BACKGROUND OF THE INVENTION

Insulating material for strands or cables containing thermoplastic copolyester elastomer (TPC), as well as strands coated therewith, are known in the art. For example, WO 2014/095598 A1 discloses an electrical cable with a cable sheath made of a polymer composition having a diameter of less than 7 mm, wherein the polymer composition contains a matting agent and a mold release agent and/or an external lubricant. The polymer composition contains a thermoplastic elastomer, such as a thermoplastic copolyester elastomer. WO 2019/014423 A1 discloses a cable comprising an electrically or optically conductive element, an insulating layer surrounding the conductive element, wherein the insulating layer contains a copolyetherester and melamine cyanurate, and/or melamine, and/or meiren and/or melam, and a sheath surrounding the insulating layer, wherein the sheath comprises a copolyetherester and melamine cyanurate and/or melamine and/or meiren and/or melam and at least one inorganic hydroxide.

Strands coated with insulating material containing thermoplastic copolyester elastomer (TPC) are used, among other things, for heating heatable media lines whereby the strands are arranged on the outside of the line wall of the media line and/or on its inside within the inner lumen of the tubular or hose-shaped media line. It is also known to embed such strands in the pipe or hose-shaped media line wall for heating. It has been shown that such heatable media lines, depending on the conditions of use, can have weaknesses in terms of their chemical resistance, which is expressed in the area of the strand sheath of the strand(s), in particular those sheathed with a thermoplastic copolyester elastomer (TPC), as this tends to crack. The result is insufficient heating of the media line provided with the strand(s) and thus its failure. In contrast, it has been shown that strands coated with fluoroethylene propylene (FEP) do not show any cracking. Studies have shown that exposing the strands to a strong alkaline base, such as concentrated caustic soda (NaOH), influences cracking. The strand insulation material, which consists of thermoplastic copolyester elastomer (TPC), is not resistant to concentrated caustic soda or sodium hydroxide. Strands coated with FEP, on the other hand, are resistant to exposure to concentrated caustic soda. It would therefore be desirable to provide resistance to NaOH also for stranded wire insulation material made from or containing TPC.

### SUMMARY OF THE INVENTION

The present invention is therefore based on the object of providing an insulating material for strands and/or cables which contains thermoplastic copolyester elastomer (TPC), strands comprising at least one strand core and at least one strand sheath with such an insulating material, cables with strands and insulating sheath made of this insulating material, a heatable media line with at least one such strand, and a method for producing such an insulating material, wherein the insulating material is in each case resistant to exposure to concentrated caustic soda solution.

The object is achieved for an insulating material containing thermoplastic copolyester elastomer (TPC) in that to provide resistance to concentrated sodium hydroxide (NaOH), at least one organic fatty acid is incorporated into the insulating material containing thermoplastic copolyester elastomer (TPC). For a stranded wire comprising at least one strand core and at least one strand sheath, the object is achieved in that the at least one strand sheath consists of or comprises an insulating material resistant to concentrated sodium hydroxide (NaOH). For a cable comprising at least two strands and at least one insulating strand encasing the at least two strands, the object is achieved in that the at least one insulating sheath for forming a resistance to concentrated sodium hydroxide (NaOH) comprises at least one layer of such an insulating material. For a heatable media line comprising at least one tubular or hose-shaped media line with at least one line wall and at least one heating element, wherein the at least one heating element for heating the at least one tubular or hose-shaped media line is arranged on the outside and/or inside thereof and/or in the line wall thereof, the object is achieved in that the at least one heating element is such a stranded wire or such a cable as mentioned above. For a method for producing such an insulating material resistant to concentrated sodium hydroxide (NaOH), the object is achieved by adding organic fatty acid to thermoplastic copolyester elastomer (TPC) and compounding thermoplastic copolyester elastomer (TPC) and the organic fatty acid. Further developments of the invention are defined in the dependent claims.

This creates an insulating material for strands and/or cables in which an organic fatty acid is incorporated into the plastic material containing thermoplastic copolyester elastomer (TPC) to provide resistance to concentrated sodium hydroxide (NaOH). The organic fatty acid neutralizes the concentrated caustic soda so that strands coated with the insulating material or cables coated with such an insulating material are no longer at risk of cracking when exposed to concentrated caustic soda. The organic fatty acid emerges on the outside of the insulating material and is available there to neutralize the concentrated caustic soda.

Advantageously, the insulating material containing thermoplastic copolyester elastomer (TPC) can be compounded with up to 3% organic fatty acid, in particular with up to 2% organic fatty acid, preferably with 0.1 to 2% organic fatty acid, in particular 1 to 2% organic fatty acid. Particularly beneficially, about 2% organic fatty acid can be added to the thermoplastic copolyester elastomer (TPC). The percentages given are percentages by weight (wt. %).

The at least one organic fatty acid can be, for example, stearic acid (C₁₈H₃₆O₂). Stearic acid can be mixed particularly well into the thermoplastic copolyester elastomer (TPC). It also supports the processing of the finished compound made of thermoplastic copolyester elastomer (TPC) and stearic acid. Furthermore, stearic acid is comparatively inexpensive, so that the costs of the mixture of thermoplastic copolyester elastomer (TPC) and stearic acid do not increase significantly compared to those of the thermoplastic copolyester elastomer (TPC). With a proportion of up to 2 wt. % stearic acid in the compound of thermoplastic copolyester elastomer (TPC) and stearic acid, the stearic acid can distribute very well in this mixture and acts as a kind of lubricant. If the weight proportion of stearic acid in the mixture is significantly exceeded (approx. 2%), it may no longer be possible to distribute it evenly in the mixture of thermoplastic copolyester elastomer (TPC) and stearic acid. This causes the mixture to start to smear, so that the melt no longer adheres to the compounding device.

The addition of, in particular, stearic acid or another organic fatty acid to the thermoplastic copolyester elastomer (TPC) is carried out by applying shear energy in order to achieve optimal compounding of TPC and the organic fatty acid, in particular stearic acid. Shear energy can be applied, for example, in a kneader and/or an extruder. An internal kneader with discharge extruder or a co-rotating twin-screw extruder are particularly suitable for this purpose, whose cams serve as kneading elements for compounding. Other kneaders or extruders in which a corresponding shear energy can be generated, such as in an internal kneader with discharge extruder or a co-rotating twin-screw extruder, are also suitable for compounding TPC and the organic fatty acid, in particular stearic acid.

For example, a weight proportion of 97.5% to 99.9% of a mixture or copolymer of thermoplastic copolyester elastomer (TPC) is compounded with a proportion of 0.1% to 2.5% organic fatty acid, in particular up to 2% stearic acid. The mixture may contain other additives or auxiliary substances. In one embodiment, 98 wt. % of a thermoplastic copolyester elastomer (TPC) with a proportion of 2 wt. % stearic acid is compounded in a co-rotating twin-screw extruder in a continuous process.

The at least one strand core of a strand coated with such a strand material can, for example, consist of copper or another electrically conductive material or an electrically conductive alloy. In addition to sheathing a strand with such an insulating material, it is also possible to provide a cable with a number of strands, wherein the strands can be sheathed or not sheathed, in particular with the insulating material described above, and with at least one insulating sheath of the cable which sheaths the at least two strands on the outside. The insulating jacket comprises one or more layers of insulating material that is resistant to concentrated sodium hydroxide (NaOH). The individual strands of the cable can therefore either be sheathed or not sheathed, in particular they can themselves already be sheathed with the above-mentioned insulating material which is resistant to concentrated sodium hydroxide (NaOH). In addition, only the cable can be provided with such an insulating sheath that is resistant to concentrated NaOH.

The compound created from TPC and organic fatty acid, especially stearic acid, is easy to process, especially due to the organic fatty acid.

What is claimed is:

1. An insulating material, comprising:
thermoplastic copolyester elastomer (TPC), wherein to provide resistance to concentrated sodium hydroxide (NaOH), at least one organic fatty acid is incorporated into the insulating material containing the thermoplastic copolyester elastomer (TPC).

2. The insulating material according to claim 1, wherein the insulating material containing thermoplastic copolyester elastomer (TPC) is compounded with up to 3% organic fatty acid.

3. The insulating material according to claim 1, wherein at least one organic fatty acid is stearic acid.

4. A stranded wire, comprising:
at least one strand core and at least one strand sheath, wherein the at least one strand sheath consists of or comprises the insulating material resistant to concentrated sodium hydroxide (NaOH) according to claim 1.

5. The stranded wire according to claim 4, wherein the at least one strand core is made of copper or another electrically conductive material or an electrically conductive alloy.

6. A cable, comprising:
at least the at least one strand core and the at least one strand sheath according to claim 4, and at least one insulating sheath encasing the at least one strand core and the at least one strand sheath, wherein the at least one insulating sheath for providing resistance to concentrated sodium hydroxide (NaOH) comprises at least one layer of the insulating material.

7. A heatable media line, comprising:
at least one tubular or hose-shaped media line with at least one line wall and at least one heating element, wherein the at least one heating element for heating the at least one tubular or hose-shaped media line is arranged on the outside and/or inside thereof and/or in the line wall thereof, wherein the at least one heating element is the stranded wire according to claim 4 or a cable comprising at least the at least one strand core and the at least one strand sheath, and at least one insulating sheath encasing the at least one strand core and the at least one strand sheath, wherein the at least one insulating sheath for providing resistance to concentrated sodium hydroxide (NaOH) comprises at least one layer of the insulating material.

8. A method for producing an insulating material resistant to concentrated sodium hydroxide (NaOH) according to claim 1, comprising the steps of:
adding the organic fatty acid to the thermoplastic copolyester elastomer (TPC) and
compounding the thermoplastic copolyester elastomer (TPC) and the organic fatty acid.

9. The method according to claim 8, wherein the compounding takes place in a kneader and/or an extruder.

10. The method according to claim 9, wherein a proportion of 97.5% to 99.9% thermoplastic copolyester elastomer (TPC) with a proportion of 0.1% to 2.5% organic fatty acid is compounded.

11. The insulating material according to claim 2, wherein the insulating material containing thermoplastic copolyester elastomer (TPC) is compounded with up to 2% organic fatty acid.

12. The insulating material according to claim 2, wherein the insulating material containing thermoplastic copolyester elastomer (TPC) is compounded with 0.1 to 2% organic fatty acid.

13. The method according to claim 9, wherein the compounding takes place in an internal kneader with discharge extruder or a co-rotating twin-screw extruder.

14. The insulating material according to claim 2, wherein at least one organic fatty acid is stearic acid.

15. A stranded wire, comprising:
at least one strand core and at least one strand sheath, wherein the at least one strand sheath consists of or comprises the insulating material resistant to concentrated sodium hydroxide (NaOH) according to claim 2.

16. The stranded wire according to claim 15, wherein the at least one strand core is made of copper or another electrically conductive material or an electrically conductive alloy.

17. A cable, comprising:
at least the at least one strand core and the at least one strand sheath according to claim 16, and at least one insulating sheath encasing the at least one strand core and the at least one strand sheath, wherein the at least one insulating sheath for providing resistance to concentrated sodium hydroxide (NaOH) comprises at least one layer of the insulating material.

18. The heatable media line, comprising:
at least one tubular or hose-shaped media line with at least one line wall and at least one heating element, wherein the at least one heating element for heating the at least one tubular or hose-shaped media line is arranged on the outside and/or inside thereof and/or in the line wall thereof, wherein the at least one heating element is the stranded wire according to claim 16 or a cable comprising at least the at least one strand core and the at least one strand sheath, and at least one insulating sheath encasing the at least one strand core and the at least one strand sheath, wherein the at least one insulating sheath for providing resistance to concentrated sodium hydroxide (NaOH) comprises at least one layer of the insulating material.

19. The method for producing an insulating material resistant to concentrated sodium hydroxide (NaOH) according to claim 2, comprising the steps of:
adding the organic fatty acid to the thermoplastic copolyester elastomer (TPC) and
compounding the thermoplastic copolyester elastomer (TPC) and the organic fatty acid.

20. The method according to claim 19, wherein the compounding takes place in a kneader and/or an extruder, and wherein a proportion of 97.5% to 99.9% thermoplastic copolyester elastomer (TPC) with a proportion of 0.1% to 2.5% organic fatty acid is compounded.
